(19) United States
(12) Patent Application Publication
(10) Pub. No.: US 2013/0320145 A1
(43) Pub. Date: Dec. 5, 2013

(54) SYSTEM AND METHOD FOR MEASURING AND METERING DEICING FLUID FROM A TANK USING A REFRACTOMETER MODULE

(71) Applicant: Titan Logix Corp., Edmonton (CA)

(72) Inventors: Gregory Joseph McGILLIS, Stoney Plain (CA); Ronald John WILLIS, Edmonton (CA); Edward G. PACHAL, St. Albert (CA)

(73) Assignee: Titan Logix Corp., Edmonton (CA)

(21) Appl. No.: 13/896,054

(22) Filed: May 16, 2013

Related U.S. Application Data
(63) Continuation of application No. 13/635,133, now abandoned.
(60) Provisional application No. 61/313,757, filed on Mar. 14, 2010.

(51) Int. Cl. B64D 15/06; G01F 23/284; G01K 11/06

(52) U.S. Cl. CPC B64D 15/06; G01K 11/06; G01F 23/2845
USPC 244/134 C; 374/16; 342/124

(57) ABSTRACT

A system and method is provided for measuring and metering deicing fluid as it is dispensed from a tank onto an aircraft to remove ice and to prevent subsequent icing. The system can include a guided wave radar gauge mounted on the tank to measure the volume of fluid in the tank in real-time. As fluid is dispensed from the tank, the gauge measures the change in the volume of fluid in the tank and transmits the volume of fluid in the tank and the volume of fluid dispensed from the tank to a display/controller. The system can also include a refractometer module to enable the measurement of the concentration of a first constituent fluid relative to a second constituent fluid in a mixture thereof. The system can further measure the concentration of one deicing fluid constituent (e.g. glycol) mixed with another fluid constituent (e.g. water) to determine the freeze point of the deicing fluid.

### CROSS-REFERENCE TO RELATED APPLICATIONS

This application claims priority of U.S. provisional patent application Ser. No. 61/313,757 filed Mar. 14, 2010 and hereby incorporates the same provisional application by reference herein in its entirety.

### TECHNICAL FIELD

The present disclosure is related to the field of systems and methods for measuring and metering a volume of fluid dispensed from a tank, in particular, systems and methods incorporating guided wave radar to measure and meter a volume of deicing fluid dispensed on an aircraft to remove frost, snow and ice, and to prevent ice buildup and other contaminants that can stick to the aircraft. The disclosure also relates to the measurement of the concentration of one fluid constituent (e.g. ethylene or propylene glycol) mixed with another fluid (e.g. water) to replace a traditional optical refractometer.

### BACKGROUND

An issue with aircraft operation in low temperature conditions is the need to accurately measure the volume of deicing fluid dispensed on a plane during deicing operations. It is necessary to monitor and report applied deicing volumes, typically for two types of fluid, referred to in the aviation industry as Type I and Type IV deicer fluids, although there are others such as Type II and Type III. Type I is applied at high temperature to remove frost, snow and ice on the aircraft, and Type IV is applied afterwards to prevent ice build up.

It is known to use a turbine flow meter with a display/controller as a flow measurement and volume totalizing method for deicing fluid application on aircraft. Turbine flow meters suffer from a number of deficiencies, the most significant being that the turbine flow meter body internals can be corroded by the ethylene or propylene glycol in the deicing fluid. Furthermore, Type IV deicing fluid needs to be measured with additional care because the turbine can break down the Type IV fluid, reducing its viscosity, thereby reducing its ability to adhere to the flying surfaces of the aircraft. In addition, the high viscosity of Type IV deicing fluid can prevent the turbine meter from accurately measuring the volume of Type IV deicing fluid dispensed. The current technology also does not alert an operator when the deicing fluid tank is empty, when the tank is too low of deicing fluid to complete the required deicing operation or when in danger of being overfilled during loading.

The freeze point of the deice fluid applied to aircraft can be directly related to the glycol concentration of the deice fluid. As the ambient temperature decreases, the glycol concentration must be increased to lower the freeze point to maintain its suitability for application to an aircraft. Suitability can be measured by holdover time, which is the maximum time an aircraft can wait prior to takeoff before it needs to be deiced again. Glycol is expensive, and operators need to keep the freeze point adequate for the ambient temperature, but not much below this temperature.

The current industry accepted technology for measurement of deicing fluid concentration in a mixture of deice fluid and water is an optical refractometer. Handheld optical refractometers are typically used, where a truck operator takes a small sample of the fluid, and places the sample on the optical refractometer to take a reading through an eyepiece. Online devices are also available, but are very expensive and their accuracy and reliability can be questionable. It is, therefore, desirable to provide a system and method to automate these concentration measurements, and for measuring, monitoring and metering deicing fluid from a tank that overcomes these deficiencies and shortcomings.

### SUMMARY

A system and method for measuring and metering deicing fluid pumped from a tank is provided. In one embodiment, the system and method can use a high accuracy guided wave radar (“GWR”) gauge, which can the combination of a GWR probe and transmitter, to measure the change of volume of deicing fluid in a tank as the deicing fluid is dispensed onto an aircraft and can then report batch totals of the amount of deicing fluid dispensed in a deicing operation. In contrast with prior art technology using turbine flow or mag meters, GWR technology has no moving parts making it suitable for both Types I and IV deicing fluids. Furthermore, because the volume of the deicing fluid in the tank is continuously measured, alarm conditions can be generated to alert an operator when the tank is empty, when the fluid level in the tank is too low to service the aircraft or when in danger of being overfilled during loading.

In one embodiment, the system and method can be used for Types I through IV deicer fluids (including Type II and III). In another embodiment, the system and method can maintain a running inventory of the liquid in the tank, similar to an “electronic dipstick”, allowing the GWR technology to combine both inventory and batch control functions in one technology or platform. In a further embodiment, the system and method can generate a high level alarm to prevent overfilling the tank, and can be connected to audible alarms and/or pump/valve controls. In yet another embodiment, the system and method can generate a low level alarm to prevent damaging pumps/valves, to warn the operator when the fluid level is too low to adequately service the aircraft, and can be connected to audible alarms and/or pump/valve controls. In yet a further embodiment, the system and method can be connected to displays to show the level of deice fluid, and also to show the total volume of deicing fluid dispensed (i.e. batch total). In another embodiment, the system and method can include a dual display where one display can show the remaining volume of deicing fluid in the tank, and where the second display can show the total volume of deicing fluid dispensed (i.e. batch total).

In another embodiment, the system can further comprise a refractometer module to provide an on-line method of measuring glycol concentration in water, using an adapted gauge and transmitter (with new firmware) already in place for level measurement. While this disclosure describes a system and method for determining the concentration of glycol with respect to water in deicing fluid so as to determine the freeze point of the deicing fluid, it is obvious to those skilled in the art that the systems, methods and techniques disclosed herein can be used to determine to concentration of a first constituent fluid relative to a second constituent fluid in a mixture thereof.

Broadly stated, in some embodiments, a system is provided for measuring and metering deicing fluid dispensed from a tank, comprising: a guided wave radar gauge, the gauge configured to be installed on or in the tank; means for measuring a volume of fluid disposed in the tank with the gauge; means for metering a portion of the volume of fluid dispensed from the tank with the gauge; and means for transmitting data from the gauge to a display unit, the data comprising information on the volume of fluid in the tank, and on the portion of the volume of fluid dispensed from the tank.

Broadly stated, in some embodiments, a method is provided for measuring and metering deicing fluid dispensed from a tank, the method comprising the steps of: providing a guided wave radar gauge, the gauge configured to be installed on or in the tank, and installing the gauge on or to the tank wherein a volume of fluid in the tank can be measured and metered; measuring a volume of fluid disposed in the tank with the gauge; metering a portion of volume of fluid dispensed from the tank with the gauge; and transmitting data from the gauge to a display, the data comprising information on the volume of fluid in the tank and on the volume of fluid dispensed from the tank.

Broadly stated, in some embodiments, a system is provided for measuring the freezing point of deicing fluid disposed in a tank, comprising: a guided wave radar gauge, the gauge adapted to be operatively coupled on or in the tank wherein the gauge is in communication with the deice fluid, the gauge further comprising a probe of a predetermined length, the probe configured to be immersed in the deice fluid; means for measuring a first time of flight of a guided wave radar signal to an air-liquid interface of the deice fluid disposed in the tank; means for measuring a second time of flight of the guided wave radar signal between the air-liquid interface and an end of the probe; means for measuring the temperature of the deice fluid; and means for calculating the freezing point of the deice fluid based on the length of the gauge, the first and second times of flight and the temperature of the deice fluid.

Broadly stated, in some embodiments, a method is provided for measuring the freezing point of deice fluid in a tank, the method comprising the steps of: providing a guided wave radar gauge, the gauge adapted to be operatively coupled on or in the tank wherein the gauge is in communication with the deice fluid, the gauge further comprising a probe having a predetermined length; measuring a first time of flight of a guided wave radar signal to an air-liquid interface of the deice fluid in the tank; measuring a second time of flight of the guided wave radar signal between the air-liquid interface and an end of the gauge; measuring the temperature of the deice fluid; and calculating the freezing point of the deice fluid based on the length of the gauge, the first and second times of flight and the temperature of the deice fluid.

Broadly stated, in some embodiments a system is provided for determining the concentration of glycol in deice fluid disposed in a tank, comprising: a guided wave radar gauge, the gauge adapted to be operatively coupled on or in the tank wherein the gauge is in communication with the deice fluid, the gauge further comprising a probe of a predetermined length, the probe configured to be immersed in the deice fluid; means for measuring a first time of flight of a guided wave radar signal to an air-liquid interface of the deice fluid disposed in the tank; means for measuring a second time of flight of the guided wave radar signal between the air-liquid interface and an end of the probe; means for measuring the temperature of the deice fluid; and means for calculating the dielectric constant of the deice fluid based on the length of the probe, the first and second times of flight and the temperature of the deice fluid, wherein the concentration of glycol in the deice fluid can be determined from the calculated dielectric constant.

Broadly stated, in some embodiments, a method is provided for determining the concentration of glycol in deice fluid disposed in a tank, the steps of the method comprising; providing a guided wave radar gauge, the gauge adapted to be operatively coupled on or in the tank wherein the gauge is in communication with the deice fluid, the gauge further comprising a probe of a predetermined length, the probe configured to be immersed in the deice fluid; measuring a first time of flight of a guided wave radar signal to an air-liquid interface of the deice fluid disposed in the tank; measuring a second time of flight of the guided wave radar signal between the air-liquid interface and an end of the probe; measuring the temperature of the deice fluid; and calculating the dielectric constant of the deice fluid based on the length of the probe, the first and second times of flight and the temperature of the deice fluid, wherein the concentration of glycol in the deice fluid can be determined from the calculated dielectric constant.

Broadly stated, in some embodiments, a system for determining the concentration of a first constituent fluid relative to a second constituent fluid in a mixture thereof, the mixture disposed in a tank, the system comprising: a guided wave radar gauge, the gauge configured to be installed on or in the tank, the gauge comprising a predetermined length; means for measuring a first time of flight of a guided wave radar signal to an air-liquid interface of the mixture in the tank: means for measuring a second time of flight of the guided wave radar signal between the air-liquid interface and an end of the gauge; means for measuring the temperature of the mixture; and means for calculating the dielectric constant of the first constituent fluid based on the length of the gauge, the first and second times of flight and the temperature of the mixture, wherein the concentration of the first constituent fluid in the mixture can be determined from the calculated dielectric constant.

Broadly stated, in some embodiments, a method for determining the concentration of a first constituent fluid relative to a second constituent fluid in a mixture thereof, the mixture disposed in a tank, the method comprising the steps of: providing a guided wave radar gauge, the gauge configured to be installed on or in the tank, the gauge comprising a predetermined length; measuring a first time of flight of a guided wave radar signal to an air-liquid interface of the mixture in the tank; measuring a second time of flight of the guided wave radar signal between the air-liquid interface and an end of the gauge; measuring the temperature of the mixture; and calculating the dielectric constant of the first constituent fluid based on the length of the gauge, the first and second times of flight and the temperature of the mixture, wherein the concentration of the first constituent fluid in the mixture can be determined from the calculated dielectric constant.

### BRIEF DESCRIPTION OF THE DRAWINGS

FIG. 1 is a block diagram depicting a system for metering deicing fluid.

FIG. 2 is a block diagram depicting the firmware imbedded in a display controller of the system of FIG. 1.

FIG. 3 is a block diagram depicting a flowchart of a real time operating system of the system of FIG. 1.

FIG. 4 is a perspective view depicting a dual rod embodiment of a guided wave radar gauge.

FIG. 5 is a perspective cutaway view depicting a coaxial embodiment of a guided wave radar gauge, the cutaway view depicting the internal signal rod.

FIG. 6 is a perspective view depicting the guided wave radar gauge of FIG. 4 and the reflected pulses generated by the air-liquid interface and also the end reflection pulse after a guided wave radar signal has passed through the fluid.

FIG. 6A is a graph depicting reflections of a pulse from an air-liquid interface and from a shorting block disposed the gauges of FIGS. 6 and 7.

FIG. 7 is a perspective view depicting the guided wave radar gauge of FIG. 5 and the reflected pulses generated by the air-liquid interface and also the end reflection pulse after a guided wave radar signal has passed through the fluid.

FIG. 8 is a graph depicting a relationship between % water concentration and the dielectric constant of in a mixture of UCAR ADF glycol and water at 10 degrees Celsius.

FIG. 9 is a graph depicting a relationship between % water concentration and the time delay of a radar signal passing through a mixture of UCAR ADF glycol and water at 10 degrees Celsius.

FIG. 10 is a graph depicting how the propagation delay of the signal passing through a fluid mixture of UCAR ADF glycol and water changes as the glycol concentration in water changes.

FIG. 11 is a graph depicting water concentration vs. time delay in a fluid mixture of UCAR ADF glycol and water for various ambient temperatures.

FIG. 12 is a reproduction of Table 1: UCAR ADF Freezing Point, Percent by Volume of UCAR ADF Concentrate in Water, and Refraction, published in the product information bulletin (Form No. 183-00021-0709 AMS, issued July 2009) produced by Dow Chemical.

FIG. 13 is a graph depicting the relationship of the freezing temperature of UCAR ADF versus time delay at various temperatures.

### DETAILED DESCRIPTION OF EMBODIMENTS

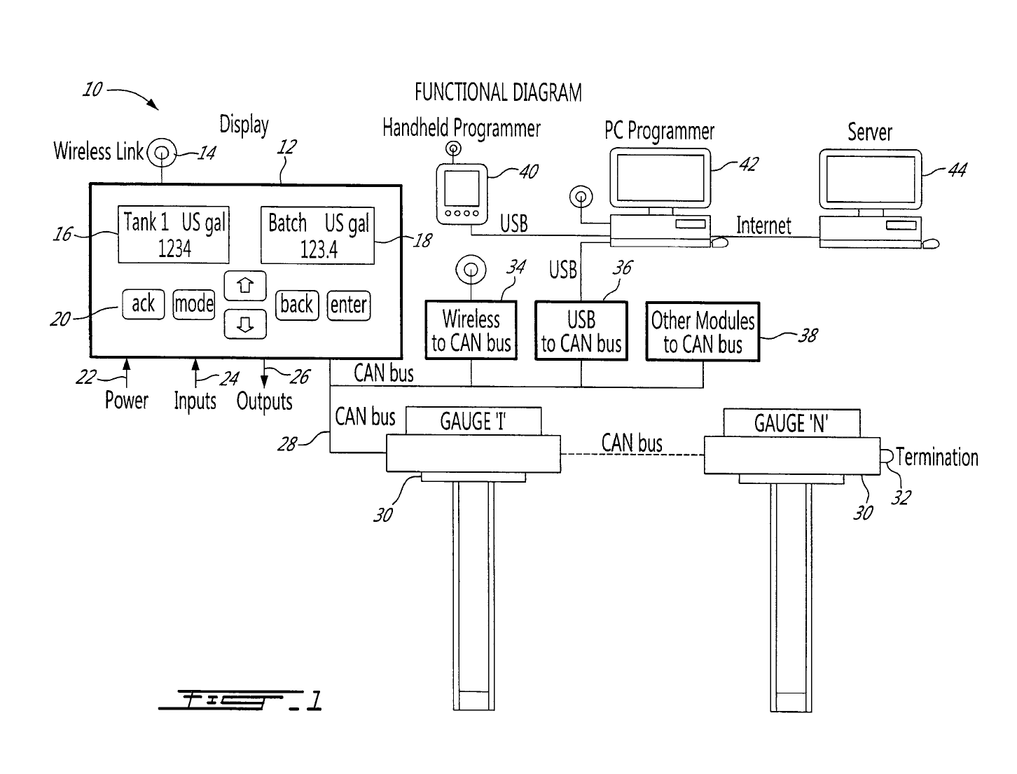

Referring to FIG. 1, system 10 for metering deicing fluid is shown. In this embodiment, at least one transmitter gauge 30 incorporating guided wave radar (“GWR”) technology can be used for the measurement of deicing fluid in a tank (not shown). The GWR electronic circuitry can be based on a time-of-flight measurement between a pulse launched down a transmitter gauge and a reflected pulse from an air-liquid interface. The level information can be sent to display unit 12, or to other device via a wired communications channel, such as controller area network (“CAN”) bus 28.

For the purposes of this specification, the following are definitions for the terms used in FIG. 1.

“Display Unit”—This can provide the user interface for operation of the liquid level sensor. It can feature two graphical output devices, and several button inputs. A number of ports can be provided for power, analog/digital inputs, relay outputs and a connector for CAN bus. A wireless module can also be built-in to enable non-contact programming of the display and transmitters.

“Power”—input port to supply power for the display and transmitter(s).

“Inputs”—analog and digital inputs to the Display Unit.

“Outputs”—relay outputs for control of pumps and valves.

“CAN bus”—Controller Area Network, a hardware protocol used for communications and power for the transmitter(s).

“Transmitter”—the transmitter with its attached gauge can be used to detect the air-liquid interface in a tank, and send this information via the CAN bus to a display (or other device). Multiple transmitters can exist on the same CAN bus to ‘N’), with the last transmitter having a Termination on its second port.

“Termination”—the CAN bus requires that the last transmitter have a termination resistor on the final port. This can normally have a value of 120 ohms, as defined by the CAN requirements.

“Wireless Link”—the wireless link can be used for noncontact communications between the Display Unit and the Handheld or PC Programmer, or an attached printer device. This can comprise Bluetooth®, WiFi® or other wireless technologies.

“Handheld Programmer”—a PocketPC (or similar device) used for wireless communications with the Display.

“PC Programmer”—a standard PC with a wireless link, or a USB to CAN wired connections for communications with the Display, the Transmitter(s), and other CAN modules.

“USB”—Universal Serial Bus, a commonly used communications method for computers.

“Wireless to CAN bus”—a module that can interface between a wireless network and a wired CAN bus network.

“USB to CAN bus”—a module that can interface between the USB bus and the CAN bus.

“Other Modules to CAN bus”—printers, high power relays, CAN-enabled temperature, pressure transducers and others.

“Server”—can be used as the central collection point for communications between a central office and the Display, Transmitter and/or other modules.

“Internet”—communications protocol used for data exchange and programming between the Display/Transmitter and Server.

In some embodiments, system 10 can comprise display unit 12 further having tank display 16 and batch display 18. Display unit 12 can comprise panel controls 20 for operating display 12. In some embodiments, display unit 12 can be connected to CAN bus 28, which can be further connected to transmitter gauges 30, wireless transceiver 34, USB interface 36 and to other modules 38, that can further comprise an in-cabin display/controller, high power relays, printers, printer interfaces, refractometer modules, a global positioning system (“GPS”) module, a temperature module, a radio interface to communicate glycol concentration to the cockpit of an aircraft, among others obvious to those skilled in the art.

In some embodiments, display unit 12 can receive the liquid level information of a tank and, by using depth charts specific to each tank, display unit 12 can calculate and display the volume of liquid remaining in the tank. In the illustrated embodiment, display can feature two graphical output devices, shown as tank display 16 and batch display 18. These can be used to show volumes in two separate tanks or, alternatively, be used in a batch mode for one tank, as shown in FIG. 1. Display unit 12 can also receive the information from a refractometer module and can present this information on tank display 16 or batch display 18.

In some embodiments, display unit 12 can receive power, such 8 to 30 VDC up to 500 mA, via power connection 22. Display unit 12 can also comprise several digital and analog inputs 24 and outputs 26, which can include temperature sensors, optical outputs, relay outputs and so on. In some embodiments, the implementation of CAN bus 28 can enable other modules to easily be added to system 10. In some embodiments, system 10 can comprise wireless module 34 and universal serial bus (“USB”) module 36. Other modules 38 can include printers, high power relays, CAN enabled temperature sensors, pressure transducers, refractometer modules and others. In other embodiments, display unit 12 can also comprise built-in wireless transceiver module 14 that can communicate over Bluetooth®, WiFi®, GPS or any other suitable wireless communication protocol obvious to those skilled in the art.

In some embodiments, programming display unit 12 and transmitters 30 can be done in one of two ways. Wireless module 14 disposed in display unit 12 can allow a non-contact or wireless method for programming with handheld programmer 40, or with personal computer (“PC”) 42. In other embodiments, programming can also be done via USB to CAN bus module 36 as shown in FIG. 1.

In some embodiments, an internet connection between PC 42 and server 44 can be used to provide a method of communication to with display unit 12 and transmitters 30 for troubleshooting purposes, remote programming, software updates and the like as obvious to those skilled in the art. Another use for this connection can be to collect data from individual tanks, with the addition of satellite or cellular modems (not shown).

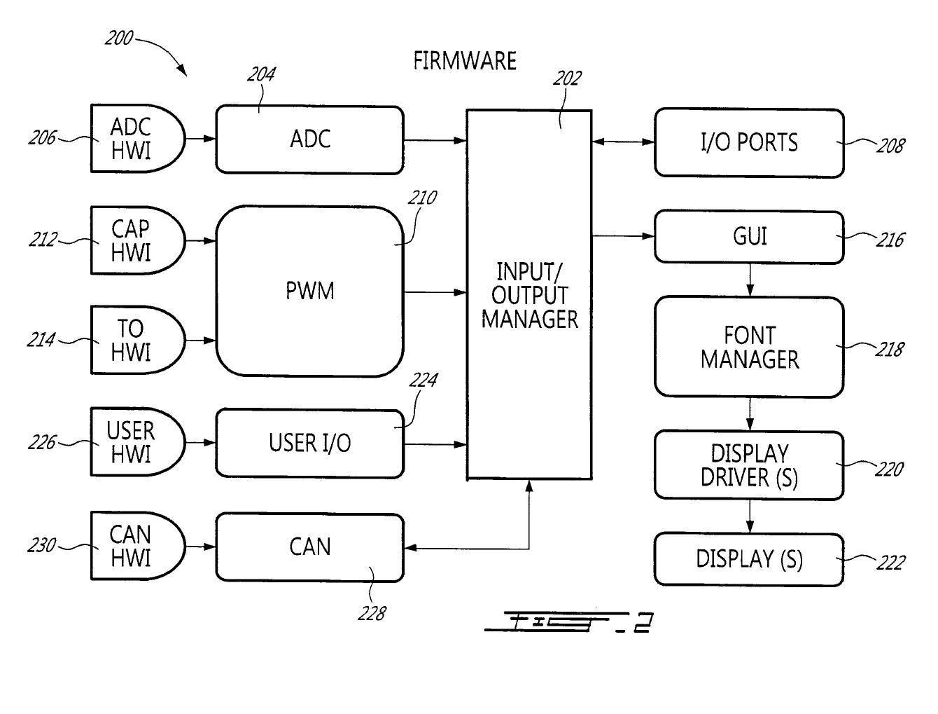

Referring to FIG. 2, a block diagram of one embodiment of firmware 200 embedded in display unit 12 is shown. In some embodiments, firmware 200 can comprise input/output manager 202 that can comprise a module that can manage tables of data for transmitter gauge number(s), CAN bus identifier(s), user input data, tank depth charts and alarm conditions, as examples. In some embodiments, input/output manager 202 can also route data or messages to the appropriate modules. Analog to digital converter (“ADC”) 204 can be operatively coupled to input/output manager 202. When a pulse is launched down transmitter gauge 30, the interaction of the pulse with an air/fluid interface in a tank results in a reflected pulse. For the purposes of this specification, the term “air” in an air/fluid interface can comprise air and/or one or more gases or vapours. In some embodiments, nitrogen gas can be used as a vapour blanket in a tank in place of air. In some embodiments, the reflected pulse can be expanded in time, and the result can be sampled by ADC 204. In other embodiments, if ADC 204 has a sufficiently fast sampling rate, then expansion of the reflected pulse in time may not be necessary. When sufficient data has been buffered, ADC 204 can cause a hardware interrupt, via ADC hardware interrupt 206, that can transfer the data to a processor.

In some embodiments, firmware can comprise pulse width modulation (“PWM”) module 210 operatively connected to input/output manager 202. In addition to sampling the reflected pulse with ADC 204, a pulse can be generated whose width is proportional to the time-of-flight of the reflected pulse. In some embodiments, the pulse can have a width of approximately 500 ps, and can further comprise a wideband signal comprising frequencies from DC to 1.6 GHz. When this pulse is generated, a capture interrupt, via capture hardware interrupt (“CAP HWI”) 212, can be provided to a processor to act as a time stamp for the reflected pulse. If no return or reflected pulse is detected, a timer overflow interrupt is sent to the processor via timer overflow hardware interrupt (“TO HWI”) 214.

In some embodiments, firmware 200 can comprise user input/output (“USER I/O”) module 224. Display unit 12 can comprise a user interface with buttons for user input. When a button is pressed, a user hardware interrupt can be sent to the processor via USER HWI 226.

In some embodiments, firmware 200 can comprise a controller area network (“CAN”). The CAN 228 hardware interface can be used for wired communications between display unit 12 and transmitter gauge 30, as well as with any other modules. Incoming messages can be filtered, parsed and routed to input/output manager 202. When these incoming messages are received from display unit 12, transmitter gauge 30 or other modules, a CAN hardware interrupt is generated via CAN HWI 230.

In some embodiments, analogue and/or digital input and output signal connections, designated as I/O PORTS 208 in FIG. 2, can be operatively connected to input/output manager 202 can be provided for relays, temperature sensors and other peripherals requiring digital and analog interfaces.

In some embodiments, firmware 200 can comprise graphic user interface (“GUI”) 216. GUI 216 can comprise all user input signals, and can manage menus and menu navigation. GUI 216 can further provide an output to Font Manager 218 that can take input from GUI 216, and can further generate graphical information for Display(s) 222 via Display Driver(s) 220 that can pass information from Font Manager 218. Display(s) 222 can provide visual feedback to a user.

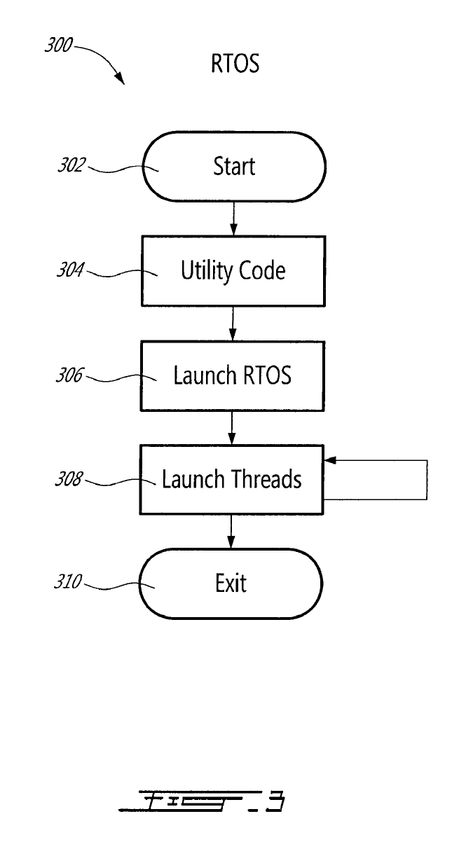

Referring to FIG. 3, a flowchart of real time operating system (“RTOS”) 300 for the system and method described herein is shown. At step 302, entitled, “Start”, RTOS 300 can start at this point when display unit 12 is powered up.

At step 304, entitled, “Utility Code”, preliminary code responsible for performing the hardware setup for the processor of display unit 12 can run. Processor input and output pins can be read, set or cleared as appropriate. ADC 204 can be initialized. Relay drivers can be initialized.

At step 306, entitled, “Launch RTOS”, RTOS 300 is launched once Utility Code 304 has completed running. After RTOS 300 is up and running, the processors can be ready to accept new tasks, under the control of RTOS 300.

At step 308, entitled, “Launch Threads”, a watchdog timer thread can be launched to ensure any error conditions do not lock up the processor. Once running, other threads can be launched to enable the Controller Area Network used for communications with other modules, capture returning pulses from transmitter gauge(s) 30, attend to other inputs/outputs, and update display unit 12. In some embodiments, several threads can be launched. The first can be an initialization thread that can run first and just once; this can get the hardware registers initialized in the processor. A second thread can run periodically and can have the sole purpose of updating a watchdog timer; if this thread fails to run, the processor can be rebooted. A third thread can handle the input and output on the communications channel, which for this application is the CAN channel, although, in general this would be for any other communications channel (e.g. an RS-485 network, a wireless link, or any other functionally equivalent communications network as well known to those skilled in the art). A fourth thread can be used for temperature compensation of the circuitry. A fifth thread can pull data from ADC 204 in the processor, can analyze the peaks for the liquid/air interface and the end reflection, can calculate the freeze point for the deice fluid, and can then send the results to the communications channel.

At step 310, entitled, “Exit”, a processor restart is generated but is only reached under abnormal conditions, i.e. when the watchdog time thread times out. When this occurs, RTOS 300 startup can be re-initialized.

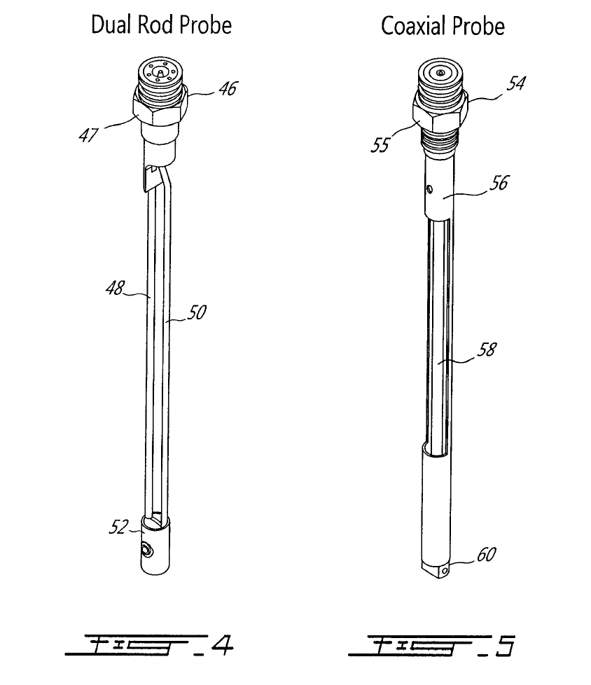

Referring to FIGS. 4 and 5, two embodiments of a transmitter gauge are shown. In FIG. 4, dual rod gauge 46 is illustrated, and can comprise two substantially parallel rods extending downwardly from transmitter coupler 47. The parallel rods can comprise signal rod 50 and ground rod 48 that can both terminate at shorting block 52. In FIG. 5, coaxial gauge 54 is illustrated, and can comprise internal signal rod 58 disposed within cylindrical ground conductor 56, both extending downwardly from transmitter coupler 55, and terminating at shorting block 60.

In operation, one or more transmitter gauges 30 can be fixed in place inside a tank or in an external stilling tube or well attached to, and in fluid communication with, the tank, as well known to those skilled in the art. These gauges can be of a variety of configurations, dependent on the nature of the liquid. A dual rod configuration is shown for transmitter gauge 30 in FIG. 1. Electronics inside transmitter gauge 30 can generate short radar pulses that can be launched down one gauge electrode whereas the other electrode is grounded. In some embodiments, the pulse can have a width of approximately 500 ps, and can further comprise a wideband signal comprising frequencies from DC to 1.6 GHz. When a radar pulse reaches an air-liquid interface, the impedance mismatch of air-liquid interface causes a portion of the radar pulse energy to be reflected back to the transmitter of transmitter gauge 30 to a detector disposed therein (not shown) as well known to those skilled in the art. An example of a suitable GWR gauge that can be used in this application is the model Deice-Stik gauge as manufactured and sold by Titan Logix Corp. of 4130-93 Street, Edmonton, Alberta, Canada. In another embodiment, a coaxial gauge can be used in place of the dual rod configuration, the coaxial gauge also available from Titan Logix.

In other embodiments, other radar techniques can be used besides transmitting pulses. These embodiments can include radio frequency admittance, radio frequency capacitance and frequency modulated continuous wave, all of which can be used for level measurement in a tank.

The two-way travel time of the pulse reflected from the air-liquid interface can be used to calculate the level of the liquid in the tank. In one embodiment, the liquid being monitored can be an ethylene or propylene glycol mixture used for deicing aircraft in low temperature conditions. However, it is obvious to those skilled in the art that the system and method can be of general use for most liquids. In other embodiments, the systems and methods described herein can be used to determine the concentration of one liquid or fluid relative to another liquid or fluid in a mixture thereof.

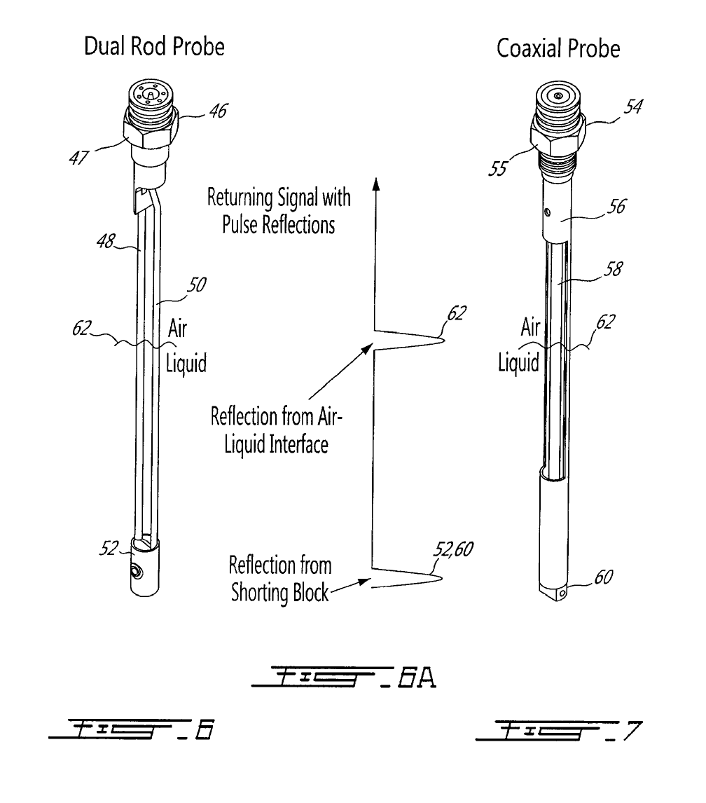

In one embodiment, system 10 can further comprise a refractometer module (not shown), as well known to those skilled in the art, that can measure the two-way travel time of a radar pulse reflected from air-liquid interface 62, and that can further measure the two-way travel time of the pulse reflected from the end of the gauge, as shown in FIGS. 6 and 7. The measurement of this time of flight within the liquid can allow certain properties of the fluid to be determined. In some embodiments, the property can comprise the dielectric constant of the fluid. In embodiments where deicing fluid is being measured to determine the glycol concentration in the fluid, the known gauge length and temperature of the fluid can be used to make this determination. Some fluids (e.g. glycol, water) absorb energy to the degree that the end reflection is not visible. For these fluids, the gauge can be modified by adding an insulating layer to the signal rod of the gauges as shown in FIGS. 4 and 5. In some embodiments, the insulating layer can be Teflon® or any other suitable material as well known to those skilled in the art. The thickness of the insulating layer can be dependent on the fluids being measured.

In operation, and in some embodiments, multiple reflected pulses can be collected and digitized by a processor disposed in system 10 into data wherein the data can be used to calculate or determine a liquid level in a tank. In other embodiments, the collected and digitized reflected pulses can be used to electronically generate a time-expanded version of the returning pulse. This is provided as input to a processor that converts said input into a liquid level. Level information is transmitted to display unit 12 (or other receiving device) via the controller area network (“CAN”) bus 28 as shown in FIG. 1, a robust hardware interface specifically designed for the transportation industry. In other embodiments, a RS-485 network can be used. In further embodiments, wireless telecommunications protocols such as Bluetooth® ear WiFi® can be used, or any other functionally equivalent protocols and/or networks as well known to those skilled in the art can be used.

In one embodiment, the refractometer module can employ firmware that looks at not only the returning pulse from the air-liquid interface, but also at the returning pulse from the end of the gauge, as shown in FIG. 5A. Referring to FIGS. 6 and 7, the gauges of FIGS. 4 and 5 are shown, respectively, each immersed in a liquid thereby defining air-liquid interface 62 disposed on signal rods 50 and 58, respectively. As a pulse transmitted from transmitter 47 or 55, a first pulse can be reflected from air-liquid interface 62 and measured by the refractometer module to produce a first time of flight measurement. In addition, a second pulse can be reflected from shorting block 52 or 60, as the case may be, and measured by the refractometer module to produce a second time of flight measurement.

As the dielectric constant of the liquid increases, the two-way time of flight from the end of probe reflection can also increase. Conversely, as the dielectric constant of the liquid decreases, the two-way time of flight from the end of probe can also decrease. These returning pulses can be provided as input to the same processor as above with the refractometer module firmware written to discern both returning pulses. Once temperature of the fluid is known, provided by a thermometer disposed in the deice fluid, and given that the length of the gauge is known, this information along with the time-of-flight information from the returning pulses can be used to calculate the dielectric constant of the fluid. The dielectric constant of the fluid can then be used to calculate the glycol concentration in the deice fluid and, thereby, the fluid freeze point of the deice fluid.

In some embodiments, an algorithm can be used to determine the freezing point of a mixture of glycol and water based on an estimated time delay of a radar signal passing through the mixture. The algorithm can be expressed as the following model or equation (1):

FP=p2×TD²+p1×TD+p0 (1)

where:

FP is the freezing point of the mixture;

TD represents the estimated time delay of a radar signal travelling through the mixture, which can be determined from the difference between the second time of flight and the first time of flight measurements; and

p0, p1 and p2 are fitting coefficients determined experimentally for various temperatures of a glycol and water mixture.

The relationship expressed in equation (1) can hold for specific fluid temperatures and types of glycol, hence, a collection of fitting coefficients were calculated and are depicted in Table 1 and Table 2 below for Kilfrost™ Type 1 deicing fluid, as manufactured by Cryotech Deicing Technology of Fort Madison, Iowa, USA, and UCAR aircraft deicing fluid (“ADF”), as manufactured by Dow Chemical of Midland, Mich., U.S.A., respectively. The coefficients can be calculated using regression methods based on a second degree polynomial as expressed in equation (1).

TABLE 1
Freezing Point Fitting Parameters of KilFrost
Samples at Different Temperatures

| Measurement | | | | |
|---|---|---|---|---|
| Temperature | p2 | p1 | p0 | R Square |
| −40 | −1.5482 | 59.773 | −618.67 | 1 |
| −30 | 0.31528 | −8.1677 | −25.265 | 0.99656 |
| −20 | −0.07215 | 14.109 | −370.8 | 0.94543 |
| −10 | 1.3669 | −55.651 | 446.27 | 0.97337 |
| 0 | −9.6268 | 575.95 | −8616.3 | 0.98642 |
| 10 | −6.6448 | 398.07 | −5961.6 | 0.97169 |
| 20 | −5.1735 | 309.53 | −4628.7 | 0.97482 |

TABLE 2
Freezing Point Fitting Parameters of UCAR
ADF Samples at Different Temperatures

| Measurement | | | | |
|---|---|---|---|---|
| Temperature | p2 | p1 | p0 | R Square |
| −40 | 3.8523 | −194.38 | 2393.3 | 1 |
| −30 | 11.934 | −670.73 | 9366.2 | 0.87172 |
| −20 | 42.017 | −2408.1 | 34451 | 0.73354 |
| −10 | −16.973 | 1032.3 | −15697 | 0.93077 |
| 0 | −17.115 | 1028.3 | −15447 | 0.97988 |
| 10 | −3.5849 | 242.47 | −4029.3 | 0.99298 |
| 20 | −21.236 | 1243.6 | −18213 | 0.96417 |

Table 1 and Table 2 indicate R square as an indication of model fitness on each case. FIG. 13 shows the freezing point of UCAR ADF at 20° C., 10° C., 0° C. and −10° C.

In order to estimate the concentration of water in a fluid mixture of water and glycol, an estimation of the freezing point of the mixture is required. The freezing point can depend directly on ambient temperature and the dielectric constant of the fluid. The dielectric constant of the fluid can be determined based on the time delay (ie., propagation delay) of a guided wave signal through the liquid mixture.

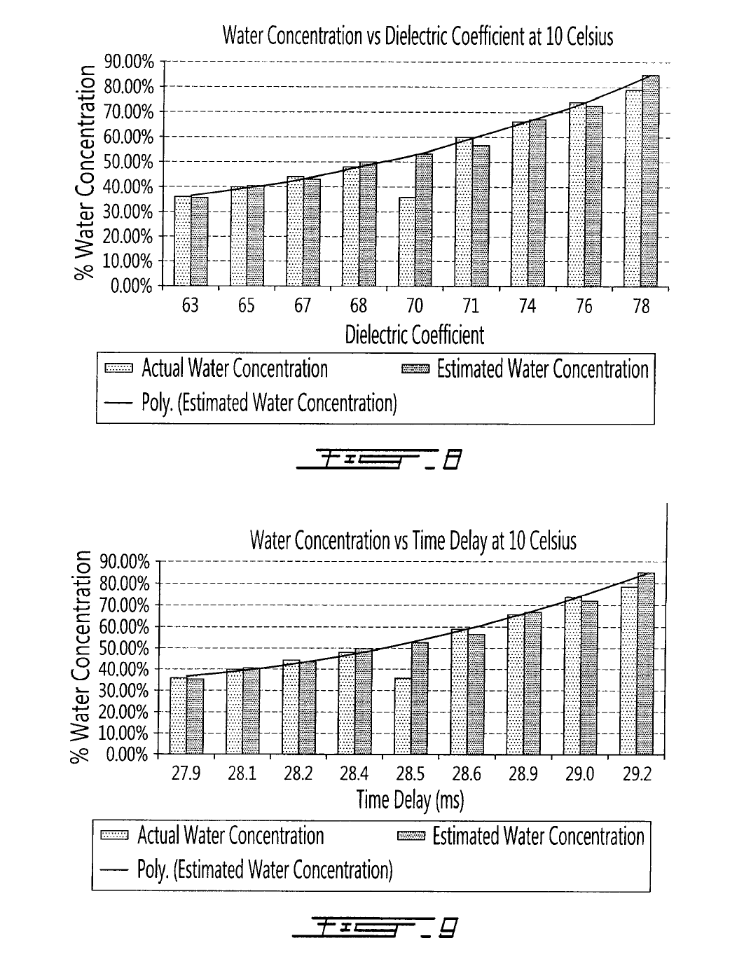

FIG. 8 shows experimental data taken from a mix of UCAR ADF glycol and water, shows the actual concentration of water in the mixture and the estimated concentration of water based on analytical models. FIG. 8 illustrates a relationship between the percentage of water concentration and the effective dielectric constant at an ambient temperature of 10° C. It is evident that the analytical models follow the experimental data at this temperature. FIG. 8 also illustrates a second order polynomial that fits the experimental data.

In some embodiments, the second order polynomial relationship between the percentage of the water concentration and the dielectric coefficient, as shown in FIG. 8, can be expressed as the following model or equation (2):

WC=0.0008DK²−0.0817DK+2.3026 (2)

where:

WC is the percentage of water concentration in the UCAR ADP a er mixture; and

DK is the dielectric coefficient of the UCAR ADF/water mixture.

This model or equation fits the experimental data with R²=99.65.

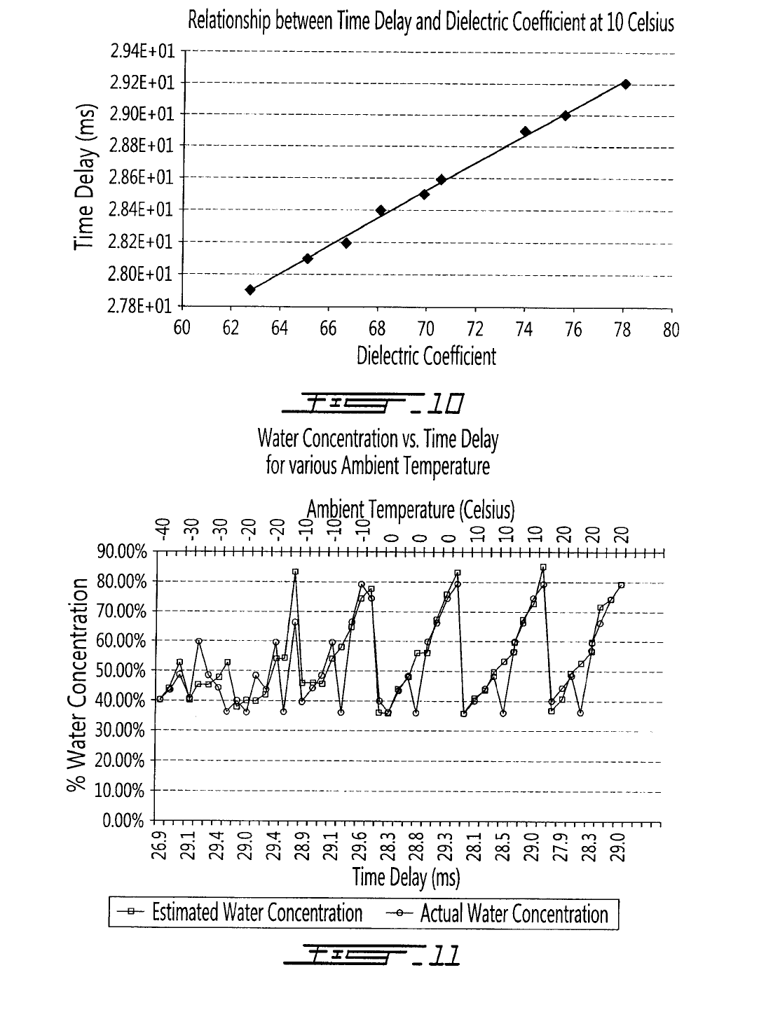

FIG. 9 illustrates the time delay (propagation delay) of a radar signal passing through a fluid mixture of UCAR ADF glycol and water. The larger the amount of water in the mixture, the greater the time delay. The illustration shows the actual water concentration in the fluid mixture as well as the estimated water concentration based on the analytical models. From the illustration, it is observed that there is a correlation between analytical and experimental values at an ambient temperature of 10° C. FIG. 9 also illustrates a second order polynomial that fits the experimental data.

In some embodiments, the second order polynomial relationship between the percentage of the water concentration and the time delay in milliseconds, as shown in FIG. 9, can be expressed as the following model or equation (3):

WC=0.1279TD²−6.9379TD+94.33 (3)

where:

WC is the percentage of water concentration in the UCAR ADF/water mixture; and

TD is the time delay of the transmitted guided wave radar pulse.

This model or equation fits the experimental data with R²=99.71.

FIG. 10 shows the relationship between the effective dielectric constant of the mixture of UCAR ADF glycol and water. The effective dielectric constant can depend on the concentration of water in the mix, where the lower the dielectric constant, the lower the concentration of water and, hence, the lower the time delay. These measurements were taken over at ambient temperatures of 10° C.

In some embodiments, the relationship that can link the time delay and the dielectric coefficient can be expressed as the following model or equation (4):

TD=0.0866DK+22.464 (4)

where:

TD is the time delay in milliseconds; and

DK is the dielectric coefficient.

This linear relationship fits the experimental data with R²=99.66.

It is observed that the models expressed in equations (2), (3) and (4) described the experimental data with a high degree of accuracy.

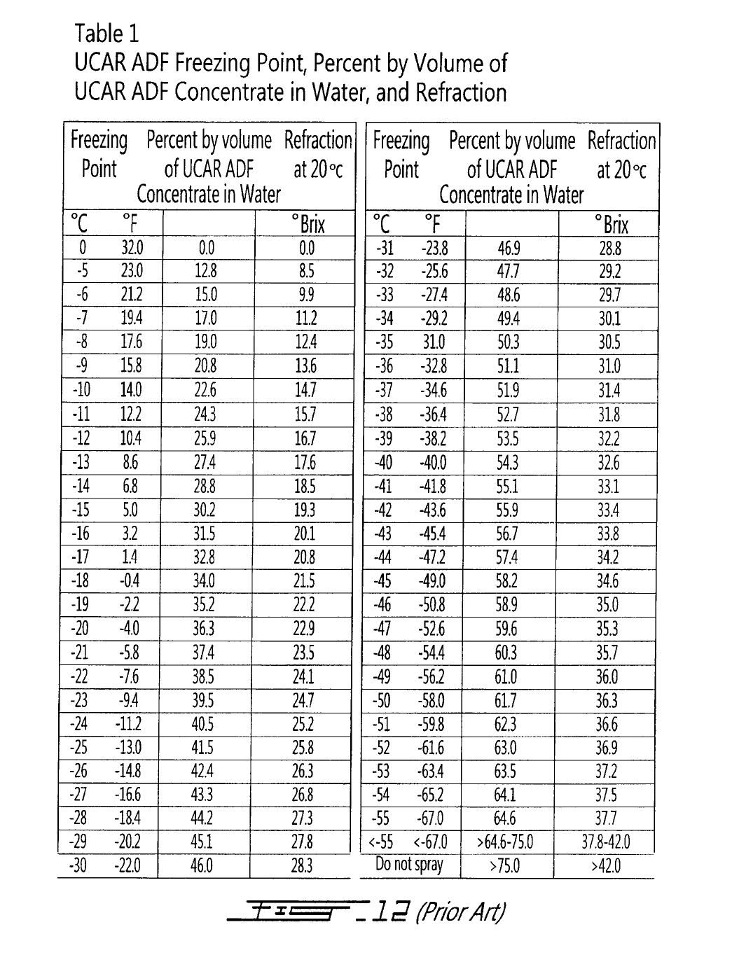

The overall process takes into consideration the time delay as a basis to estimate the final water concentration in the fluid mixture. FIG. 11 illustrates the actual and estimated water concentration of a UCAR ADF and water mixture based on experimental data. It is evident that it is feasible to make adequate estimations of water concentration in a mix of glycol and water through analytical models. The experimental data shown in FIG. 11 was collected over a wide range of ambient temperatures [−54° C. to +20° C.].

In order to arrive at the percentage concentrations of water based on freezing points we used a comparison table (Table 1: UCAR ADF Freezing Point, Percent by Volume of UCAR ADF Concentrate in Water, and Refraction) published in the “product information bulletin (Form No. 183-00021-0709 AMS, issued July 2009)” available online at: http://msdssearch.dow.com/PublishedLiteratureDOWCOM/dh 02dd/0901b803802d d0b5.pdf?filepath=aircraft/pdfs/noreg/183-00021.pdf&fromPage=GetDoc,

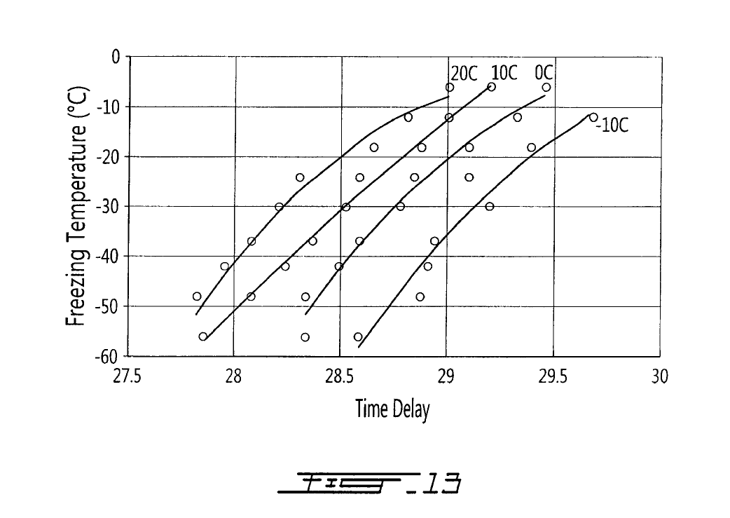

said document incorporated by reference into this application in its entirety. Table 1, as mentioned above, is reproduced in this application as FIG. 12.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

1. A system for measuring and metering deicing fluid dispensed from a tank, comprising:
a) a guided wave radar gauge, the gauge configured to be installed on or in the tank;
b) means for measuring a volume of fluid disposed in the tank with the gauge;
c) means for metering a portion of the volume of fluid dispensed from the tank with the gauge; and
d) means for transmitting data from the gauge to a display unit, the data comprising information on the volume of fluid in the tank, and on the portion of the volume of fluid dispensed from the tank.

2. The system as set forth in claim 1, wherein the means for measuring the volume of fluid comprises a refractometer module operatively coupled to the gauge.

3. The system as set forth in claim 1, wherein the means for metering the portion of volume of fluid comprises a pump operatively coupled to the fluid in the tank.

4. The system as set forth in claim 1, wherein the means for transmitting data comprises a data communication network operatively coupling the gauge to the display unit.

5. A method for measuring and metering deicing fluid dispensed from a tank, the method comprising the steps of:
a) providing a guided wave radar gauge, the gauge configured to be installed on or in the tank, and installing the gauge on or to the tank wherein a volume of fluid in the tank can be measured and metered;
b) measuring a volume of fluid disposed in the tank with the gauge;
c) metering a portion of volume of fluid dispensed from the tank with the gauge; and
d) transmitting data from the gauge to a display, the data comprising information on the volume of fluid in the tank and on the volume of fluid dispensed from the tank.

6. The method as set forth in claim 5, wherein the step of measuring the volume of fluid disposed in the tank comprises the use of a refractometer module operatively coupled to the gauge.

7. The method as set forth in claim 5, wherein the step of metering the portion of the volume of fluid dispensed from the tank comprises the use of a pump.

8. The method as set forth in claim 5, wherein the step of transmitting comprises the use of a data communication network operatively coupling the gauge to the display unit.

9. A system for measuring the freezing point of deicing fluid disposed in a tank, comprising:
a) a guided wave radar gauge, the gauge adapted to be operatively coupled on or in the tank wherein the gauge is in communication with the deice fluid, the gauge further comprising a probe of a predetermined length, the probe configured to be immersed in the deice fluid;
b) means for measuring a first time of flight of a guided wave radar signal to an air-liquid interface of the deice fluid disposed in the tank;
c) means for measuring a second time of flight of the guided wave radar signal between the air-liquid interface and an end of the probe;
d) means for measuring the temperature of the deice fluid; and
e) means for calculating the freezing point of the deice fluid based on the length of the gauge, the first and second times of flight and the temperature of the deice fluid.

10. The system as set forth in claim 9, wherein the means for measuring the first and second times of flight comprises a refractometer module operatively coupled to the gauge.

11. The system as set forth in claim 9, wherein the means for measuring the temperature comprises a thermometer disposed in the deice fluid.

12. The system as set forth in claim 9, wherein the means for calculating the freezing point of the deice fluid comprises means for carrying out an algorithm that uses the first and second times of flight as inputs to an equation.

13. A method for measuring the freezing point of deice fluid in a tank, the method comprising the steps of:
a) providing a guided wave radar gauge, the gauge adapted to be operatively coupled on or in the tank wherein the gauge is in communication with the deice fluid, the gauge further comprising a probe having a predetermined length;
b) measuring a first time of flight of a guided wave radar signal to an air-liquid interface of the deice fluid in the tank;
c) measuring a second time of flight of the guided wave radar signal between the air-liquid interface and an end of the gauge;
d) measuring the temperature of the deice fluid; and
e) calculating the freezing point of the deice fluid based on the length of the gauge, the first and second times of flight and the temperature of the deice fluid.

14. The method as set forth in claim 13, wherein the step of measuring the first and second times of flight comprises the use of a refractometer module operatively coupled to the gauge.

15. The method as set forth in claim 13, wherein the step of measuring the temperature comprises the use of a thermometer disposed in the deice fluid.

16. The method as set forth in claim 13, wherein the step of calculating the freezing point comprises means for carrying out an algorithm that uses the first and second times of flight as inputs to an equation.

17. A system for determining the concentration of glycol in deice fluid disposed in a tank, comprising:
a) a guided wave radar gauge, the gauge adapted to be operatively coupled on or in the tank wherein the gauge is in communication with the deice fluid, the gauge further comprising a probe of a predetermined length, the probe configured to be immersed in the deice fluid;
b) means for measuring a first time of flight of a guided wave radar signal to an air-liquid interface of the deice fluid disposed in the tank;
c) means for measuring a second time of flight of the guided wave radar signal between the air-liquid interface and an end of the probe;
d) means for measuring the temperature of the deice fluid; and
e) means for calculating the dielectric constant of the deice fluid based on the length of the probe, the first and second times of flight and the temperature of the deice fluid, wherein the concentration of glycol in the deice fluid can be determined from the calculated dielectric constant.

18. The system as set forth in claim 17, wherein the means for measuring the first and second times of flight comprises a refractometer module operatively coupled to the gauge.

19. The system as set forth in claim 17, wherein the means for measuring the temperature comprises a thermometer disposed in the deice fluid.

20. A method for determining the concentration of glycol in deice fluid disposed in a tank, the steps of the method comprising:
a) providing a guided wave radar gauge, the gauge adapted to be operatively coupled on or in the tank wherein the gauge is in communication with the deice fluid, the gauge further comprising a probe of a predetermined length, the probe configured to be immersed in the deice fluid;
b) measuring a first time of flight of a guided wave radar signal to an air-liquid interface of the deice fluid disposed in the tank;
c) measuring a second time of flight of the guided wave radar signal between the air-liquid interface and an end of the probe;
d) measuring the temperature of the deice fluid; and
e) calculating the dielectric constant of the deice fluid based on the length of the probe, the first and second times of flight and the temperature of the deice fluid, wherein the concentration of glycol in the deice fluid can be determined from the calculated dielectric constant.

21. The method as set forth in claim 20, wherein the step of measuring the first and second times of flight comprises the use of a refractometer module operatively coupled to the gauge.

22. The method as set forth in claim 20, wherein the step of measuring the temperature comprises the use of a thermometer disposed in the deice fluid.
